(19) United States
(12) Patent Application Publication
(10) Pub. No.: US 2024/0157918 A1
(43) Pub. Date: May 16, 2024

(54) BRAKING SYSTEM, COMPUTER-IMPLEMENTED METHOD OF DECELERATING A RAIL VEHICLE, COMPUTER PROGRAM AND NON-VOLATILE DATA CARRIER

(71) Applicant: DELLNER BUBENZER AB, BORLÄNGE (SE)

(72) Inventor: Viktor PRIM, SANDVIKEN (SE)

(21) Appl. No.: 18/282,268

(22) PCT Filed: Nov. 10, 2021
(86) PCT No.: PCT/EP2021/081228

§ 371 Date: Sep. 15, 2023

(30) Foreign Application Priority Data
Mar. 15, 2021 (EP) 21162663.5

(51) Int. Cl. B60T 8/1761; B60T 8/17; B60T 8/171; B60T 8/172; B60T 8/32

(52) U.S. Cl. CPC B60T 8/17616; B60T 8/1705; B60T 8/171; B60T 8/172; B60T 8/3235; B60T 2201/03; B60T 2240/02; B60T 2250/00; B60T 2270/413

(57) ABSTRACT

A rail vehicle has at least two railroad cars (111, 112, 11n) and a braking system with control units (121-1, 121-2, 122-1, 122-2, 12n-1, 12n-2) at least one of which is arranged in each railroad car. Each control unit receives a brake input signal (B), and in response thereto generates a control signal (c₁₁, c₁₂, c₁₃, c₁₄, c₂₁, c₂₂, c₂₃, c₂₄, cₙ₁, cₙ₂, cₙ₃, cₙ₄). The control signals are generated on the further basis of at least one motion parameter expressing a respective movement of the railroad cars (111, 112, 11n). At least one brake actuator (131₁ₐ, 131_{1b}, 131₂ₐ, 131_{2b}, 131₁ₐ, 131_{1b}, 131₂ₐ, 131_{2b}, 13n₁ₐ, 13n_{1b}, 13n₂ₐ, 13n_{2b}) is arranged in each railroad car. Each brake actuator receives the control signal generated by a control unit in the same railroad car as the brake actuator is located, and based thereon produces a brake-force signal (f₁₁, f₁₂, f₁₃, f₁₄, f₂₁, f₂₂, f₂₃, f₂₄, fₙ₁, fₙ₂, fₙ₃, fₙ₄) to a brake unit (141-1, 141-2, 141-3, 141-4, 142-1, 142-2, 142-3, 142-4, 14n-1, 14n-2, 14n-3, 14n-4). In response thereto, each brake unit causes a pressing member to apply a braking force to a rotatable member so as to reduce a rotation speed of at least one wheel of a railroad car in the rail vehicle.

### TECHNICAL FIELD

The present invention relates generally to deceleration control of rail vehicles. Especially, the invention relates to a braking system for a rail vehicle containing two or more railroad cars, and a computer-implemented method of decelerating such a rail vehicle. The invention also relates to a computer program and a non-volatile data carrier storing such a computer program.

### BACKGROUND

A rail vehicle's brakes are employed to control the deceleration of the rail vehicle and to implement a parking brake function. Typically, the same brakes are used both for service braking and emergency braking. Traditional rail vehicle brakes are dependent on a load input, i.e. data reflecting the weights of each railroad car. Today's rail vehicles are often regulated using compressed air, known as pneumatically regulated brakes. One disadvantage of such pneumatic brakes is that they cannot be regulated quickly. Due to the slow regulation, the system is dependent on knowing a gross weight reflecting the load on the individual bogies of the rail vehicle. The brakeforce is applied in relation to the load, and inter alia represents an important input to various anti-slip and anti-wheel-lock mechanisms. Nevertheless, in general, more load translates into a higher brake force.

US 2002/0088673 discloses an apparatus and method for incorporating a feedback mechanism into a train railcar wheel braking system to regulate applied braking force. The feedback mechanism provides information to an electronically controlled pneumatic braking system sufficient to detect impending wheel slip or skid. Responsive to the wheel slip/skid information, a brake control processor modulates the braking force applied to the train railcar wheel system to enable the braking system to apply a braking force without damaging the railcar wheel system or rails over which the railcar wheels are traveling.

US 2010/0078991 describes a brake device for braking a vehicle has a brake surface which is rotationally fixedly connected to a wheel axle of the vehicle, a brake lining which can be pressed with a braking force against the brake surface and an actuating element coupled to a control unit, for generating the braking force. The control unit is connected to a speed sensor for measuring a speed of the vehicle and is set up to adjust the braking force in dependence on the speed. The brake device has as high a braking force as possible which is introduced into the brake surfaces. The control unit is coupled to the actuating element via a device for continuous pressure adjustment, so as to enable a continuous adaptation of the braking force to the present speed in each case. The braking force is advantageously adjusted inversely proportionally to the speed of the vehicle.

US 2020/0198605 shows a microcomputer-controlled electromechanical braking system comprises an electromechanical braking control device and an electromechanical braking unit. The electromechanical braking control device comprises a braking microcomputer control unit, an electromechanical control unit and a standby power supply module. The braking microcomputer control unit receives a braking instruction signal sent by a driver or an automatic driving system, performs the calculation of a target braking force and braking management, and at the same time, can communicate with braking microcomputer control units of other vehicles in a train group.

Thus, solutions are known for producing continuously adapted braking forces during braking, for instance aiming at avoiding wheel slip. The prior art also contains examples of braking systems where control units in different railroad cars of a train vehicle communicate with one another to improve the braking performance. Common for the known solutions is that they all rely on load information to control the braking operations. This means that, in one way or the other, the weight of each railroad car forms a basis for how different brakes are applied. However, the load information is an unreliable parameter because imperfect scales provide inaccurate measures, and the bogie loads may vary during travel as passengers may walk between the railroad cars.

### SUMMARY

The object of the present invention is therefore to offer a solution that solves the above problem and enables efficient, safe and reliable braking of a rail vehicle without having to consider load information.

According to one aspect of the invention, the object is achieved by a braking system for a rail vehicle having at least two railroad cars, which braking system contains a number of control units, a number of brake actuators and a number of brake units. At least one control unit is arranged in each one of the railroad cars. Each of the control units is configured to receive a brake input signal, and in response thereto generate a respective control signal. The brake input signal may for example be generated in response to a service brake command issued by an operator, an emergency brake command issued manually or automatically, or a parking brake command issued manually or automatically. Further, at least one brake actuator is arranged in each railroad car, and each brake actuator is configured to receive the control signal generated by a control unit in the same railroad car as the brake actuator. Based on the received control signal, the brake actuator is configured to produce a brake-force signal. Each brake unit contains a pressing member and a rotatable member being mechanically linked to at least one wheel of one of the railroad cars. Each brake unit is configured to receive the brake-force signal produced by the brake actuator in the same railroad car as the brake unit. In response to the brake-force signal, the brake unit is configured to cause the pressing member to apply a braking force to the rotatable member so as to reduce a rotation speed of the at least one wheel. Moreover, in addition to the brake input signal, each control unit is configured to generate the control signal on the basis of at least one motion parameter expressing a respective movement of each of the railroad cars.

The above braking system is advantageous because it enables fast and individually adapted control of the brakes in each railroad car. Not only does this, in turn, translate into a low degree of jerk in the rail vehicle, it also allows each individual railroad car to utilize its full brake potential. Consequently, a shortest possible brake distance is attainable. The system further obtains a faster response time than a traditional load-based system, which results in less wheel flats. Since the braking system is well suited for electric/optic control, it is lighter than a traditional brake system being controlled based on pneumatic/hydraulic control. It should be noted, however, that nothing precludes that the braking system according to the invention is applied to pneumatically/hydraulically controlled brakes.

According to one embodiment of this aspect of the invention, the rail vehicle contains a first communication bus, e.g. of an electronic or optic format, configured to feed the brake input signal to each of the railroad cars. The first communication bus may either be fed in parallel to all the control units, be fed in series from one control unit to the other, or be fed to the control unit according to a hybrid series and parallel format, such as in parallel to each railroad car and in series between different control units within a railroad car. Nevertheless, the first communication bus enables reliable and speedy distribution of the brake input signal in the entire rail vehicle.

According to another embodiment of this aspect of the invention, each of the railroad cars contains at least one accelerometer configured to produce at least one vector signal representing an acceleration in at least one dimension of the railroad car in which the at least one accelerometer is placed, for example lengthwise the railroad car. The at least one vector signal expresses the respective movement of the railroad car on the further basis upon which the brake input signal is produced. Consequently, the at least one control unit is configured to receive the at least one vector signal, and based thereon generate the control signal. This is advantageous because such acceleration data form a solid basis for assigning adequate braking forces in the respective railroad cars.

According to yet another embodiment of this aspect of the invention, alternatively or in addition to producing the above-mentioned at least one vector signal, each of the least two railroad cars contains at least one a rotational speed sensor configured to produce at least one speed signal representing a respective speed of a wheel of the railroad car containing the at least one a rotational speed sensor. Thus, the rotational speed sensor may for example be arranged on a wheel and/or an axle of the railroad car. In any case, the at least one speed signal expresses the movement of the railroad car; and analogous to the above, the control unit is configured to receive the at least one speed signal, and based thereon generate the control signal. Such speed measurements are advantageous because the wheel speed constitutes a firm basis for assigning adequate braking forces in the respective railroad cars.

According to still another embodiment of this aspect of the invention, each of the control units is configured to: receive at least one of the at least one motion parameter expressing the respective movement of each other railroad car comprised in the rail vehicle; determine an average motion parameter based on the at least one received motion parameter and an own motion parameter expressing the movement the railroad car in which said respective one control unit is comprised; and generate the control signal such that it causes the brake actuator controlled by the respective one control unit to produce a respective brake-force signal to the at least one brake unit causing the at least one pressing member to apply an increased braking force, if the own motion parameter expresses that the movement of the railroad car has a magnitude larger than what is expressed by the average motion parameter. In other words, the braking force will be increased for a railroad car having an above-average magnitude of motion. Provided that the applied braking force is repeatedly updated at short intervals, this vouches for a short braking distance and a relatively low degree of jerk.

Preferably, each of the control units is further configured to generate the control signal such that it causes the brake actuator controlled by the respective one control unit to produce a respective brake-force signal to the at least one brake unit causing the at least one pressing member to apply a decreased braking force, if the own motion parameter expresses that the movement of the railroad car has a magnitude smaller than what is expressed by the average motion parameter. Thereby, the overall degree of jerk may be reduced further.

Moreover, it is preferable if each of the control units is configured to generate the control signal such that it causes the brake actuator controlled by the respective one control unit to produce a respective brake-force signal to the at least one brake unit causing the at least one pressing member to apply a maintained braking force, should the own motion parameter express that the movement the railroad car has a magnitude equal to what is expressed by the average motion parameter. Although, in practice, this may be unusual, such a strategy is likewise beneficial with respect to attaining a low degree of jerk during braking.

According to another embodiment of this aspect of the invention, the rail vehicle contains a second communication bus configured to exchange the motion parameters between the railroad cars, which motion parameters express the respective movements of the railroad cars included in the rail vehicle. The second communication bus may either be separate from the first communication bus physically and/or logically, or form a physically integrated part thereof and/or form a logically integrated part thereof. In any case, a bus format is generally preferred because it provides an efficient means of exchanging data between the different railroad cars.

According to yet another embodiment of this aspect of the invention, each of the railroad cars in the rail vehicle contains at least one respective battery unit, which is configured to provide electric energy to the control units and the brake actuators positioned in the same railroad car as the least one respective battery unit. A respective one of the least one battery unit may be comprised in or be co-located with each control unit, or two or more control units and/or two or more brake actuators may share a common battery unit. In the latter case, the battery unit is preferably not integrated into a control unit. However, from a technical point-of view, this is not excluded either. In any case, the battery units provide an important back-up source of energy for effecting the braking functionality in case a main electric supply to the braking system is broken.

Preferably, each of the railroad cars also contains at least one battery charger configured to charge the at least one respective battery unit during operation of the rail vehicle so as to ensure that the at least battery unit is operative when needed.

In a braking system comprising pneumatically/hydraulically controlled brakes, accumulator tanks holding pressurized gas/fluid may serve as replacements for batteries to provide emergency brake functionality in case of a malfunctioning brake control system.

According to still another embodiment of this aspect of the invention, each of the at least one wheel whose rotation speed one of the brake actuators is configured to cause to reduce is a wheel whose rotation is monitored by a measurement module configured to produce a slip signal reflecting a degree of slip of the at least one wheel. Each of the brake actuators is configured to receive the slip signal, and if the degree of slip exceeds a threshold value, the brake actuator is configured to produce the brake-force signal such that the brake unit causes the pressing member to apply a braking force to the rotatable member, which braking force is lower than a braking force designated by the received control signal. Consequently, the risk of wheel slip/lock may kept low. This, in turn, is beneficial with respect to braking distance as well as to avoid so-called flat spots or wheel flats.

According to another aspect of the invention, the object is achieved by a computer-implemented method of decelerating a rail vehicle including at least two railroad cars, each of which contains: at least one control unit, at least one brake actuator and at least one brake unit. The method involves: receiving a brake input signal in each of the control units; generating, in each of the control units, a respective control signal in response to the brake input signal; and receiving each of the respective control signals in one of the brake actuators in the same railroad car as the control unit which produced the control signal is positioned. Further, the method involves: producing, in each of the brake actuators, a respective brake-force signal based on the control signal; receiving each of the respective brake-force signals in one of the brake units in the same railroad car as the brake actuator which produced the brake-force signal is positioned, and causing, in each brake unit, a pressing member to apply a braking force to the rotatable member so as to reduce a rotation speed of at least one wheel of at least one railroad car in response to the brake-force signal. Specifically, the method involves, generating in each of the control units, the respective control signal on the further basis of at least one motion parameter expressing a respective movement of each of the railroad cars. The advantages of this method, as well as the preferred embodiments thereof are apparent from the discussion above with reference to the proposed control unit.

According to a further aspect of the invention, the object is achieved by a computer program loadable into a non-volatile data carrier communicatively connected to a processing unit. The computer program includes software for executing the above method when the program is run on the processing unit.

According to another aspect of the invention, the object is achieved by a non-volatile data carrier containing the above computer program.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 schematically illustrates a rail vehicle in which one embodiment of the system according to the invention is implemented;

FIG. 2a shows an accelerometer for registering railroad car movements according to one embodiment of the invention;

FIG. 2b shows sensors for registering railroad car movements in the form of a wheel speed and a wheel slip according to embodiments of the invention;

FIG. 3 shows a block diagram of a control unit according to one embodiment of the invention;

FIG. 4 shows a block diagram of a brake actuator according to one embodiment of the invention; and

FIG. 5 illustrates, by means of a flow diagram, the method according to a preferred embodiment of the invention.

### DETAILED DESCRIPTION

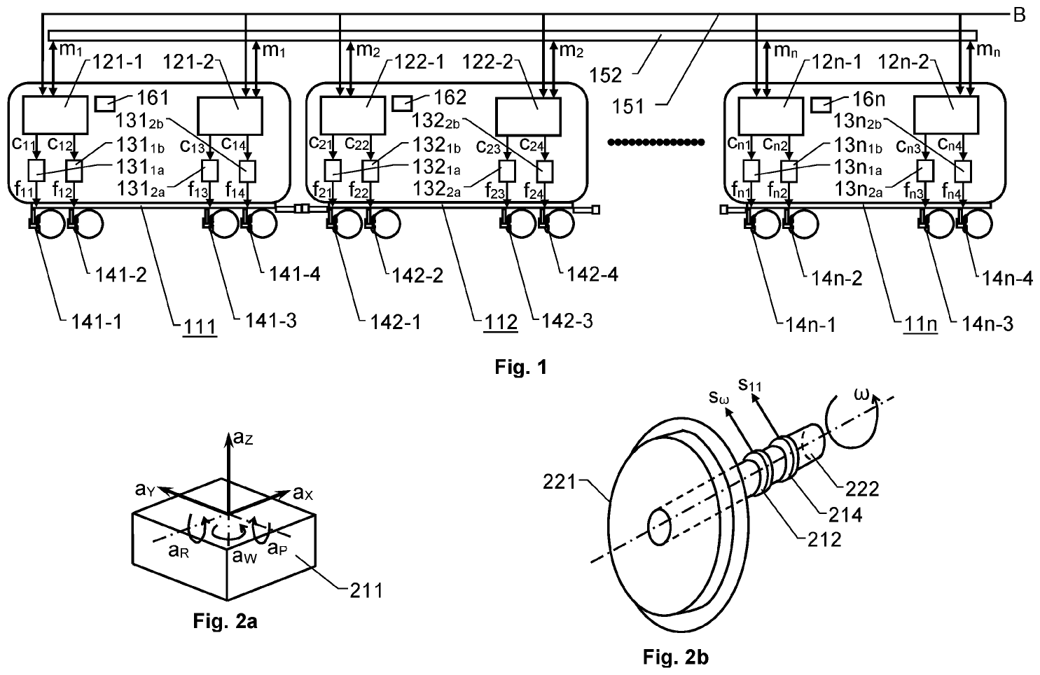

In FIG. 1, we see a schematic illustration of a rail vehicle in which one embodiment of the invention is implemented.

The rail vehicle contains at least two railroad cars, here exemplified by 111, 112 and up to 11n, where n may designate any number from say 3 to 200. The rail vehicle is equipped with a braking system, which, in turn, includes: a number of control units 121-1, 121-2, 122-1, 122-2, 12n-1 and 12n-2; a number of brake actuators 131₁ₐ, 131_{1b}, 131₂ₐ, 131_{2b}, 131₁ₐ, 131_{1b}, 131₂ₐ, 131_{2b}, 13n₁ₐ, 13n_{1b}, 13n₂ₐ and 13n_{2b}; and a number of brake units 141-1, 141-2, 141-3, 141-4, 142-1, 142-2, 142-3, 142-4, 14n-1, 14n-2 14n-3 and 14n-4.

The control units 121-1, 121-2, 122-1, 122-2, 12n-1 and 12n-2 arranged in the railroad cars 111, 112 and 11n so that there is at least one control unit in each railroad car, for example one per railroad car or one per bogie of each railroad car.

In any case, each control unit is configured to receive a brake input signal B designating a braking action to be effected. For instance the brake input signal B may have been generated in response to a service brake command, an emergency brake command or a parking brake command. Each of these commands may, in turn, be produced manually (i.e. by a human operator), or automatically by safety and/or comfort mechanisms in the rail vehicle.

The brake input signal B may be fed in parallel to all the railroad cars 111, 112 and 11n as illustrated in FIG. 1, or be fed in series to the railroad cars 111, 112 and 11n, for example first to the railroad car 111; then from the railroad car 111 to the second railroad car 112, and so on. Alternatively, the brake input signal B may be fed to the railroad cars 111, 112 and 11n in a hybrid parallel and series manner, where for example the brake input signal B reaches all the railroad cars 111, 112 and 11n in parallel, however within each railroad car, the brake input signal B can be distributed in series from one control unit to the other.

It is generally preferable if the rail vehicle has a first communication bus 151 configured to feed the brake input signal B to each of the at least two railroad cars 111, 112 and 11n, for example from a locomotive in the rail vehicle (not shown). Preferably, according to the invention, the locomotive is regarded to be a frontmost railroad car in the rail vehicle, which may or may not be configured to also carry passengers and/or goods. The first communication bus 151 may be of electronic or optic format.

Alternatively, instead of using a bus format, data and control signals may be exchanged between the railroad cars 111, 112 and 11n on an analog format, for example employing pulse width modulation.

In response to the brake input signal B, each of the control units 121-1, 121-2, 122-1, 122-2, 12n-1 and 12n-2 is configured to generate at least one control signal c₁₁, c₁₂, c₁₃, c₁₄, c₂₁, c₂₂, c₂₃, c₂₄, cₙ₁, cₙ₂, cₙ₃ and cₙ₄ respectively, which control signal designates a desired brake force to be applied. For example, an operator may produce a service brake command designating 40% of a full braking capacity. In case of emergency braking, the brake input signal B is equivalent to 100% of the full braking capacity.

Each brake actuator 131₁ₐ, 131_{1b}, 131₂ₐ, 131_{2b}, 131₁ₐ, 131_{1b}, 131₂ₐ, 131_{2b}, 13n₁ₐ, 13n_{1b}, 13n₂ₐ and 13n_{2b} respectively is configured to receive a control signal generated by one of the control units located in the same railroad car as the brake actuator itself. For example, a control unit 121-1 may feed control signals c₁₁ and c₁₂ to the brake actuators 131₁ₐ and 131_{1b}, which, in turn, feed resulting brake-force signals f₁₁ and f₁₂ to the brake units 141-1 and 141-2 respectively, each of which brake unit 141-1 and 141-2 is responsible for braking a separate wheel pair in a particular bogie, say the front bogie of the first railroad car 111. Analogously, each remaining control unit 122-1, 122-2, 12n-1 and 12n-2 may be configured to control the braking of a respective bogie in the railroad cars 111, 112 and 11n of the rail vehicle.

Based on the respective control signals c₁₁, c₁₂, c₁₃, c₁₄, c₂₁, c₂₂, c₂₃, c₂₄, cₙ₁, cₙ₂, cₙ₃ and cₙ₄, each brake actuator 131₁ₐ, 131_{1b}, 131₂ₐ, 131_{2b}, 131₁ₐ, 131_{1b}, 131₂ₐ, 131_{2b}, 13n₁ₐ, 13n_{1b}, 13n₂ₐ and 13n_{2b} is configured to produce a brake-force signal f₁₁, f₁₂, f₁₃, f₁₄, f₂₁, f₂₂, f₂₃, f₂₄, fₙ₁, fₙ₂, fₙ₃ and fₙ₄ respectively, which is fed to a particular brake unit 141-1, 141-2, 141-3, 141-4, 142-1, 142-2, 142-3, 142-4, 14n-1, 14n-2, 14n-3 and 14n-4. Each of the brake units has a pressing member and a rotatable member that is mechanically linked to at least one wheel of a railroad car 111, 112, or 11n.

The brake units are configured to receive the brake-force signals f₁₁, f₁₂, f₁₃, f₁₄, f₂₁, f₂₂, f₂₃, f₂₄, fₙ₁, fₙ₂, fₙ₃ and fₙ₄ produced by the brake actuators 131₁ₐ, 131_{1b}, 131₂ₐ, 131_{2b}, 131₁ₐ, 131_{1b}, 131₂ₐ, 131_{2b}, 13n₁ₐ, 13n_{1b}, 13n₂ₐ and 13n_{2b} respectively. Specifically, a given brake unit receives a brake-force signal produced by a brake actuator located in the same railroad car as the brake unit itself, for example as described above and illustrated in FIG. 1. In response to the brake-force signal, f₁₁, f₁₂, f₁₃, f₁₄, f₂₁, f₂₂, f₂₃, f₂₄, fₙ₁, fₙ₂, fₙ₃ and fₙ₄, the brake units 141-1, 141-2, 141-3, 141-4, 142-1, 142-2, 142-3, 142-4, 14n-1, 14n-2, 14n-3 and 14n-4 respectively cause the pressing member to apply a braking force to the rotatable member so as to reduce a rotation speed of the at least one wheel to which the rotatable member is mechanically linked.

According to the invention, not only the brake input signal B serves a basis for the control signal c₁₁, c₁₂, c₁₃, c₁₄, c₂₁, c₂₂, c₂₃, c₂₄, cₙ₁, cₙ₂, cₙ₃ and cₙ₄. Namely, each of the control units 121-1, 121-2, 122-1, 122-2, 12n-1 and 12n-2 is configured to generate the respective control signal c₁₁, c₁₂, c₁₃, c₁₄, c₂₁, c₂₂, c₂₃, c₂₄, cₙ₁, cₙ₂, cₙ₃ and cₙ₄ on the further basis of at least one motion parameter expressing a respective movement m₁, m₂ and mₙ of the railroad cars 111, 112 and 11n.

As is well known in the art, there exists various forms of a articulated railroad cars, for example in commuter trains and tramway vehicles. In rail vehicles with this type of railroad cars, so-called Jacobs bogies are commonly used. Jacobs bogies are arranged between two carriages, or segments of an articulated railroad car. Thereby, the weight of the adjoining carriages/segments is spread across the Jacobs bogie. This design provides a smooth ride of bogie carriages without requiring any additional weight and drag. In the present invention, the segments of an articulated railroad car being connected over a Jacobs bogie are considered to form part of one and the same railroad car. Consequently, these segments will be assigned an identical movement m₁, m₂ or mₙ according to the above.

According to one embodiment of the invention, it is presumed that the brake actuators are electrically controlled. Therefore, each of the railroad cars 111, 112 and 11n contains at least one battery unit 161, 162 and 16n respectively. The battery units 161, 162 and 16n are configured to provide electric energy to the control units 121-1, 121-2, 122-1, 122-2, 12n-1 and 12n-2 and the brake actuators 131₁ₐ, 131_{1b}, 131₂ₐ, 131_{2b}, 131₁ₐ, 131_{1b}, 131₂ₐ, 131_{2b}, 13n₁ₐ, 13n_{1b}, 13n₂ₐ and 13n_{2b} located in the same railroad car as the at least one battery unit 161, 162 and 16n itself is located. The battery unit 161, 162 or 16n may be comprised in, or be co-located with each, a particular one of the control units 121-1, 121-2, 122-1, 122-2, 12n-1 and 12n-2.

In any case, two or more control units, e.g. 121-1 and 121-2, in a particular railroad car 111 may share a common battery unit 161. Similarly, two or more brake actuators, e.g. 131₁ₐ, 131_{1b}, 131₂ₐ, and 131_{2b}, in a particular railroad car 111 may share a common battery unit 161. If the battery unit 161 constitutes such a shared resource, it is preferably not integrated into one of the control units. However, from a technical point-of view, this is not excluded either. In any case, the battery units provide an important back-up source of energy for effecting the braking functionality in case a main electric supply to the braking system is broken.

According to one embodiment of the invention, at least one battery charger (not shown) is included in each of the railroad cars 111, 112 and 11n, which at least one battery charger is configured to charge the at least one battery unit 161, 162 and 16n during operation of the rail vehicle. Hence, reliable backup energy can always be provided to the braking system.

It is worth noticing that, in a braking system wherein the brakes are controlled pneumatically/hydraulically, accumulator tanks holding pressurized gas/fluid may serve as battery equivalents to provide backup sources of energy enabling brake functionality in case of a malfunctioning brake control system.

FIG. 2a shows an accelerometer 211 for registering the movements m₁, m₂ and mₙ of the railroad cars 111, 112 and 11n respectively according to one embodiment of the invention.

An accelerometer as exemplified by 211 is comprised in each of the railroad cars 111, 112 and 11n, and each accelerometer is configured to produce at least one vector signal representing an acceleration in at least one dimension of the railroad car in which the at least one accelerometer 211 is comprised. For example, the at least one accelerometer 211 may produce vector signals expressing respective accelerations in the three spatial directions a_{X}, a_{Y} and a_{Z} and/or rotational accelerations yaw a_{R}, pitch a_{P} and roll aw of the railroad car. In any case, the at least one vector signal expresses the respective movement m₁, m₂ and mₙ of the railroad cars 111, 112 and 11n respectively.

Further, each of the control units 121-1, 121-2, 122-1, 122-2, 12n-1 and 12n-2 is configured to receive each of the at least one vector signal from each accelerometer in each railroad car 111, 112 and 11n in the rail vehicle, and based thereon generate the control signals c₁₁, c₁₂, c₁₃, c₁₄, c₂₁, c₂₂, c₂₃, c₂₄, cₙ₁, cₙ₂, cₙ₃ and cₙ₄ respectively.

FIG. 2b shows a rotational speed sensor 212 for registering the movements m₁, m₂ and mₙ of the railroad cars 111, 112 and 11n respectively according to another embodiment of the invention.

Here, each of the railroad cars 111, 112 and 11n contains at least one rotational speed sensor exemplified by 212, which at least one rotational speed sensor 212 is configured to produce at least one speed signal s_{ω} representing a respective speed ω of a wheel 221 of the railroad car in which the at least one rotational speed sensor 212 is comprised. Thus, the rotational speed sensor 212 may have sensor elements arranged on one or more wheels and/or on one or more axles of a railroad car. In any case, the at least one speed signal s_{ω} expresses the movement m₁, m₂ and mₙ respectively of the railroad car.

Analogous to the above, each of the control units 121-1, 121-2, 122-1, 122-2, 12n-1, 12n-2 is configured to receive the at least one speed signal s_{ω} from each railroad car 111, 112 and 11n in the rail vehicle, and based thereon generate the control signal c₁₁, c₁₂, c₁₃, c₁₄, c₂₁, c₂₂, c₂₃, c₂₄, cₙ₁, cₙ₂, cₙ₃ and cₙ₄ respectively.

According to one embodiment of the invention, each control unit, for example 121-1 in the railroad car 111, is configured to receive at least one of the at least one motion parameter expressing the respective movement of each other railroad car 112 and 11n in the rail vehicle, i.e. m₂ and mₙ respectively.

The control unit 121-1 is further configured to determine an average motion parameter m_{avg} based on the at least one received motion parameter m₂ and mₙ, and an own motion parameter expressing the movement m₁ the railroad car in which the control unit 121-1 is comprised. Here, the motion parameters expressing the movements m₁, m₂ and mₙ may for example be represented by respective speed signals s_{ω} and/or respective accelerations ay lengthwise the railroad cars 111, 112 and 11n.

Moreover, the control unit 121-1 is configured to generate the respective control signal c₁₁ and c₁₂ such that it causes the brake actuators 131₁ₐ and 131_{1b} respectively controlled by the control unit 121-1 to produce brake-force signals f₁₁ and f₁₂ respectively causing the pressing members of the brake units 141-1 and 141-2 to apply braking forces being modified relative to what would be given by the brake input signal B alone. Specifically, the control unit 121-1 is configured to generate the respective control signal c₁₁ and c₁₂ such that it causes the brake actuators 131₁ₐ and 131_{1b} to produce a respective brake-force signal f₁₁ and f₁₂ to the brake units 141-1 and 141-2 resulting in an increased braking force, if the own motion parameter expresses that the movement m₁ of the railroad car 111 has a magnitude larger than what is expressed by the average motion parameter m_{avg}. In other words, if the own railroad car 111 runs somewhat faster than a current average magnitude of motion of the railroad cars in the rail vehicle, the brakes in the own railroad car 111 will brake a bit harder.

Similarly, according to one embodiment of the invention, each control unit 121-1 is configured to generate the control signal c₁₁ and c₁₂ such that it causes the brake actuators 131₁ₐ and 131_{1b} respectively controlled by the control unit 121-1 to produce the respective brake-force signals f₁₁ and f₁₂ to the brake units 141-1 and 141-2 causing the at least one pressing member to apply a decreased braking force, if the own motion parameter expresses that the movement m₁ of the railroad car 111 has a magnitude smaller than what is expressed by the average motion parameter m_{avg}. In other words, if the own railroad car 111 runs somewhat slower than a current average magnitude of motion of the railroad cars in the rail vehicle, the brakes in the own railroad car 111 will brake a bit less hard. This results in a relatively jerk free braking process.

Exactly how much harder or less hard the brake shall be controlled if the own railroad car 111 is found to run faster or slower respectively than the current average magnitude of motion of the railroad cars in the rail vehicle is a design parameter, which inter alia depends on how often the motion parameters expressing the movements m₁, m₂ and mₙ are updated.

According to one embodiment of the invention, each control unit 121-1 is configured to generate the control signal c₁₁ and c₁₂ such that it causes the brake actuators 131₁ₐ and 131_{1b} respectively controlled by the control unit 121-1 to produce the respective brake-force signals f₁₁ and f₁₂ to the brake units 141-1 and 141-2 causing the at least one pressing member to apply a maintained braking force, if the own motion parameter expresses that the movement m₁ of the railroad car 111 has a magnitude equal to what is expressed by the average motion parameter m_{avg}. In other words, if the own railroad car 111 has a magnitude of motion coinciding with a current average magnitude of motion of the railroad cars in the rail vehicle, the brakes in the own railroad car 111 will continue to brake as they do in order to attain an overall smooth braking process.

According to one embodiment of the invention, the rail vehicle includes a second communication bus 152, which is configured to exchange the motion parameters expressing the respective movements m₁, m₂ and mₙ of the railroad cars 111, 112 and 11n respectively. The second communication bus 152 may be of electronic or optic format, and the second communication bus 152 may either be physically and/or logically separate from the first communication bus 151, or the second communication bus 152 may form a physically integrated part of the first communication bus 151, and/or the second communication bus 152 may form a logically integrated part of first communication bus 151. In any case, a communication bus is generally preferred for exchanging the motion parameters because the bus format provides an efficient means of exchanging data between the different railroad cars 111, 112 and 11n.

Referring again to FIG. 2b, according to one embodiment of the invention, a measurement module 214 is arranged at each wheel 221 whose rotation speed ω one of the brake actuators 131₁ₐ, 131_{1b}, 131₂ₐ, 131_{2b}, 131₁ₐ, 131_{1b}, 131₂ₐ, 131_{2b}, 13n₁ₐ, 13n_{1b}, 13n₂ₐ and 13n_{2b} is configured to cause to reduce, which measurement module 214 is configured to produce a slip signal s₁₁ reflecting a degree of slip of the wheel 221. Further, each brake actuator, for instance 131₁ₐ, is configured to receive the slip signal s₁₁, and if the degree of slip exceeds a threshold value, the brake actuator 131₁ₐ is configured to produce the brake-force signal f₁₁ such that the brake unit 141-1 causes the pressing member to apply a braking force to the rotatable member, which braking force is lower than a braking force designated by the received control signal c₁₁ alone. This results in a comparatively short braking distance while the braking process is kept relatively jerk free.

Exactly how much the braking force shall be lowered is a design parameter, which inter alia depends on the threshold value for the degree of slip and how often the slip signal s₁₁ is updated.

It is further advantageous if two or more of the brake actuators 131₁ₐ, 131_{1b}, 131₂ₐ, 131_{2b}, 131₁ₐ, 131_{1b}, 131₂ₐ, 131_{2b}, 13n₁ₐ, 13n_{1b}, 13n₂ₐ and 13n_{2b} exchange slip-related information between one another. Namely, this enables a second brake unit, e.g. 141-2, to take over a part of the braking responsibility from a first brake unit, e.g. 141-1, if the degree of slip exceeds the threshold value in the first brake unit, however not the second brake unit.

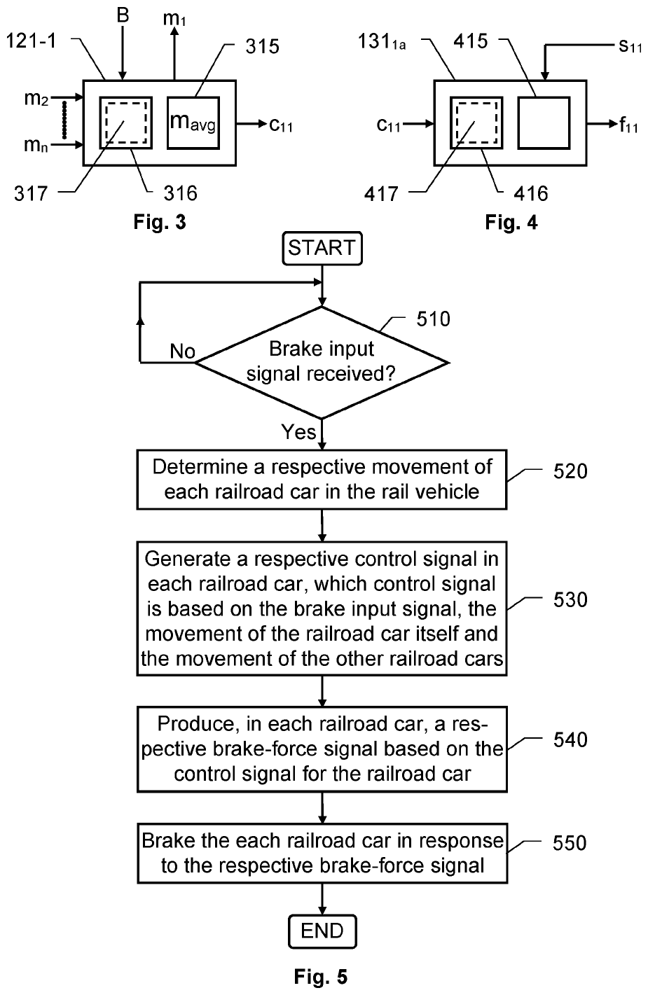

It is generally advantageous if the above-described braking procedure is effected in an automatic manner by executing one or more computer programs. Therefore, each control unit and brake actuator respectively preferably includes processing circuitry and programmed memory units, the designs of which will be briefly described below with reference to FIGS. 3 and 4.

FIG. 3 shows a block diagram of a control unit 121-1 according to one embodiment of the invention. The control unit 121-1 includes processing circuitry in the form of at least one processor 315 and a memory unit 316, i.e. non-volatile data carrier, storing a computer program 317, which, in turn, contains software for making the at least one processor 315 execute the actions mentioned in this disclosure when the computer program 317 is run on the at least one processor 315.

As explained above, the control unit 121-1 is configured to receive the brake input signal B and the motion parameters expressing the respective movements m₂ and mₙ of the other railroad cars 112 and 11n in the rail vehicle; and output at least one control signal, here exemplified by c₁₁.

FIG. 4 shows a block diagram of a brake actuator 131₁ₐ according to one embodiment of the invention. The brake actuator 131₁ₐ includes processing circuitry in the form of at least one processor 415 and a memory unit 416, i.e. non-volatile data carrier, storing a computer program 417, which, in turn, contains software for making the at least one processor 415 execute the actions mentioned in this disclosure when the computer program 417 is run on the at least one processor 415.

As explained above, the brake actuator 131₁ₐ is configured to receive the control signal c₁₁, and preferably the slip signal s₁₁; and output the brake-force signal f₁₁.

Naturally, although the control unit 121-1 and the brake actuator 131₁ₐ have been described as separate entities above, these entities may equally well be partially or fully co-located with/integrated into one another. In particular, according to the invention, at least one control unit and at least one brake actuator, two or more control units and/or two or more brake actuators may share common processing resources.

In order to sum up, and with reference to the flow diagram in FIG. 5, we will now describe the computer-implemented method according to the invention of decelerating a rail vehicle, which contains at least two railroad cars, where each railroad car includes at least one control unit, at least one brake actuator and at least one brake unit.

A first step 510, checks if a brake input signal has been received. If so, a step 520 follows; and otherwise, the procedure loops back and stays in step 510.

In step 520, a respective movement of each railroad car is determined, for example via acceleration measurements and/or wheel speed measurements. Thereafter, a step 530 follows that generates, in each of the control units, a respective control signal. Here, each control signal is generated in response to the brake input signal. The control signal is based on the movement of the railroad car itself and the movement of the other railroad cars. As discussed above, a relationship between the movement of the railroad car itself and the average movement of all the railroad cars in the rail vehicle may influence an applied brake force up or down relative to what is stipulated by the received brake input signal.

The control signals generated in step 530 are fed to respective brake actuators. Specifically, each control unit feeds its control signal to one or more brake actuators located in the same railroad car as the control unit itself.

In a step 540 subsequent to step 530, each brake actuator produces a respective brake-force signal based on the control signal received from the control unit. Each brake-force signal is fed to one or more brake units located in the same railroad car as the brake actuator itself.

Then, in a step 550, each brake unit causes a pressing member to apply a braking force to a rotatable member mechanically linked to at least one wheel of a railroad car so as to reduce a rotation speed of the at least one wheel in response to the brake-force signal.

Thereafter the procedure ends. Of course, in practice, step 510 may be reactivated, for example to check if a renewed brake input signal has been received.

All of the process steps, as well as any sub-sequence of steps, described with reference to FIG. 5 may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal, which may be conveyed, directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures, but may be varied freely within the scope of the claims.

1. A braking system for a rail vehicle comprising at least two railroad cars (111, 112, 11n), the braking system comprising:
a number of control units (121-1, 121-2, 122-1, 122-2, 12n-1, 12n-2) at least one of which is arranged in each one of the at least two railroad cars (111, 112, 11n), each of said at least two control units being configured to receive a brake input signal (B), and in response thereto generate a control signal (c11, c12, c13, c14, c21, c22, c23, c24, cn1, cn2, cn3, cn4);
a number of brake actuators (1311a, 1311b, 1312a, 1312b, 1311a, 1311b, 1312a, 1312b, 13n1a, 13n1b, 13n2a, 13n2b) arranged in each of the at least two railroad cars, each of which brake actuator is configured to receive the control signal (c11, c12, c13, c14, c21, c22, c23, c24, cn1, cn2, cn3, cn4) generated by one of the at least one control unit comprised in the same railroad car as the brake actuator, and based on the control signal, produce a brake-force signal (f11, f12, f13, f14, f21, f22, f23, f24, fn1, fn2, fn3, fn4); and
a number of brake units (141-1, 141-2, 141-3, 141-4, 142-1, 142-2, 142-3, 142-4, 14n-1, 14n-2, 14n-3, 14n-4) each comprising a pressing member and a rotatable member being mechanically linked to at least one wheel of one of the at least two railroad cars (111, 112, 11n), each of which brake unit is configured to receive the brake-force signal (f11, f12, f13, f14, f21, f22, f23, f24, fn1, fn2, fn3, fn4) produced by the brake actuator comprised in the same railroad car as the brake unit, and in response to the brake-force signal, cause the pressing member to apply a braking force to the rotatable member to reduce a rotation speed of the at least one wheel, wherein
the at least one control unit (121-1, 121-2, 122-1, 122-2, 12n-1, 12n-2) is configured to generate the control signal (c11, c12, c13, c14, c21, c22, c23, c24, cn1, cn2, cn3, cn4) on the further basis of at least one motion parameter (aX, aY, aZ, aR, aP, aW; ω) expressing a respective movement (m1, m2, mn) of each of the at least two railroad cars (111, 112, 11n).

2. The braking system according to claim 1, wherein the rail vehicle comprises a first communication bus (151) configured to feed the brake input signal (B) to each of the at least two railroad cars (111, 112, 11n).

3. The braking system according to claim 1, wherein:
each of the least two railroad cars (111, 112, 11n) comprises at least one accelerometer (211) configured to produce at least one vector signal representing an acceleration (aX, aY, aZ, aR, aP, aW) in at least one dimension of the railroad car in which the at least one accelerometer (211) is found, which at least one vector signal expresses the respective movement (m1, m2, mn) of said railroad car, and
the at least one control unit (121-1, 121-2, 122-1, 122-2, 12n-1, 12n-2) is configured to receive the at least one vector signal, and based thereon generate the control signal (c11, c12, c13, c14, c21, c22, c23, c24, cn1, cn2, cn3, cn4).

4. The braking system according to claim 1, wherein:
each of the least two railroad cars (111, 112, 11n) comprises at least one rotational speed sensor (212) configured to produce at least one speed signal (sω) representing a respective speed (ω) of a wheel (221) of the railroad car in which the at least one rotational speed sensor (212) is found, which at least one speed signal (sω) expresses the movement (m1, m2, mn) of said railroad car, and
the at least one control unit (121-1, 121-2, 122-1, 122-2, 12n-1, 12n-2) in said railroad car is configured to receive the at least one speed signal (sω), and based thereon generate the control signal (c11, c12, c13, c14, c21, c22, c23, c24, cn1, cn2, cn3, cn4).

5. The braking system according to claim 1, wherein each of said control units (121-1, 121-2, 122-1, 122-2, 12n-1, 12n-2) is configured to:
receive at least one of the at least one motion parameter expressing the respective movement (m2, mn) of each other railroad car found in the rail vehicle;
determine an average motion parameter (mavg) based on the at least one received motion parameter and a motion parameter expressing the movement (m1) the railroad car in which said respective one control unit (121-1) is found; and
generate the control signal (c11, c12) to cause the brake actuator (1311a, 1311b) controlled by said respective one control unit (121-1) to produce a respective brake-force signal (f11, f12) to the at least one brake unit (141-1; 141-2), causing the at least one pressing member to apply an increased braking force, if the motion parameter expresses the movement (m1) of the railroad car (111) has a magnitude larger than what is expressed by the average motion parameter (mavg).

6. The braking system according to claim 5, wherein each of said control units (121-1, 121-2, 122-1, 122-2, 12n-1, 12n-2) is configured to generate the control signal (c11, c12) to cause the brake actuator (1311a, 1311b) controlled by said respective one control unit (121-1) to produce a respective brake-force signal (f11, f12) to the at least one brake unit (141-1; 141-2), causing the at least one pressing member to apply a decreased braking force, if the motion parameter expresses that the movement (m1) of the railroad car (111) has a magnitude smaller than what is expressed by the average motion parameter (mavg).

7. The braking system according to claim 5, wherein each of said control units (121-1, 121-2, 122-1, 122-2, 12n-1, 12n-2) is configured to generate the control signal (c11, c12) to cause the brake actuator (1311a, 1311b) controlled by said respective one control unit (121-1) to produce a brake-force signal (f11, f12) to the at least one brake unit (141-1; 141-2), causing the at least one pressing member to apply a maintained braking force, if the motion parameter expresses the movement (m1) the railroad car (111) has a magnitude equal to what is expressed by the average motion parameter (mavg).

8. The braking system according to claim 3, wherein the rail vehicle comprises a second communication bus (152) configured to exchange the motion parameters expressing the respective movements (m1, m2, mn) of the railroad cars (111, 112, 11n) in the rail vehicle between said railroad cars (111, 112, 11n).

9. The braking system according to claim 1, wherein each of the at least two railroad cars (111, 112, 11n) in the rail vehicle comprises at least one respective battery unit (161, 162, 16n) configured to provide electric energy to the control units (121-1, 121-2, 122-1, 122-2, 12n-1, 12n-2) and the brake actuators (1311a, 1311b, 1312a, 1312b, 1311a, 1311b, 1312a, 1312b, 13n1a, 13n1b, 13n2a, 13n2b) in the same railroad car as the least one respective battery unit.

10. The braking system according to claim 9, wherein each of the at least two railroad cars (111, 112, 11n) in the rail vehicle comprises at least one battery charger configured to charge the at least one respective battery unit (161, 162, 16n) during operation of the rail vehicle.

11. The braking system according to claim 1, wherein the brake input signal (B) has been generated in response to at least one of a service brake command, an emergency brake command and a parking brake command.

12. The braking system according to claim 1, wherein:
each of at least one wheel (221) whose rotation speed (ω) one of said brake actuators (1311a, 1311b, 1312a, 1312b, 1311a, 1311b, 1312a, 1312b, 13n1a, 13n1b, 13n2a, 13n2b) is configured to reduce, is a wheel (221) whose rotation is monitored by a measurement module (214) configured to produce a slip signal (s11) reflecting a degree of slip of the at least one wheel (221), and
each of said brake actuators (1311a) is configured to receive the slip signal (s11), and if the degree of slip exceeds a threshold value, the brake actuator (1311a) is configured to produce the brake-force signal (f11) such that the brake unit (141-1) causes the pressing member to apply a braking force to the rotatable member, which braking force is lower than a braking force designated by the received control signal (c11).

13. A computer-implemented method of decelerating a rail vehicle comprising at least two railroad cars (111, 112, 11n) each of which comprises: at least one control unit (121-1, 121-2, 122-1, 122-2, 12n-1, 12n-2), at least one brake actuator (1311a, 1311b, 1312a, 1312b, 1311a, 1311b, 1312a, 1312b, 13n1a, 13n1b, 13n2a, 13n2b), and at least one brake unit (141-1, 141-2, 141-3, 141-4, 142-1, 142-2, 142-3, 142-4, 14n-1, 14n-2, 14n-3, 14n-4), the method comprising:
receiving a brake input signal (B) in each of said control units (121-1, 121-2, 122-1, 122-2, 12n-1, 12n-2),
generating, in each of said control units, a respective control signal (c11, c12, c13, c14, c21, c22, c23, c24, cn1, cn2, cn3, cn4) in response to the brake input signal (B);
receiving each of the respective control signals (c11, c12, c13, c14, c21, c22, c23, c24, cn1, cn2, cn3, cn4) in one of the brake actuators (1311a, 1311b, 1312a, 1312b, 1311a, 1311b, 1312a, 1312b, 13n1a, 13n1b, 13n2a, 13n2b) in the same railroad car as the control unit which produced the control signal,
producing, in each of the brake actuators, a respective brake-force signal (f11, f12, f13, f14, f21, f22, f23, f24, fn1, fn2, fn3, fn4) based on the control signal (c11, c12, c13, c14, c21, c22, c23, c24, cn1, cn2, cn3, cn4);
receiving each of the respective brake-force signals (f11, f12, f13, f14, f21, f22, f23, f24, fn1, fn2, fn3, fn4) in one of the brake units (141-1, 141-2, 141-3, 141-4, 142-1, 142-2, 142-3, 142-4, 14n-1, 14n-2, 14n-3, 14n-4) in the same railroad car as the brake actuator which produced the brake-force signal, each brake unit comprising a pressing member and a rotatable member being mechanically linked to at least one wheel of the at least two railroad cars (111, 112, 11n), and
causing, in each brake unit, the pressing member to apply a braking force to the rotatable member to reduce a rotation speed of the at least one wheel of the at least one railroad car (111, 112, 11n) in response to the brake-force signal, by generating, in each of the control units, the respective control signal (c11, c12, c13, c14, c21, c22, c23, c24, cn1, cn2, cn3, cn4) on the further basis of at least one motion parameter (aX, aY, aZ, aR, aP, aW; ω) expressing a respective movement (m1, m2, mn) of each of the at least two railroad cars (111, 112, 11n).

14. The method according to claim 13, comprising: feeding the brake input signal (B) to each of the at least two railroad cars (111, 112, 11n) via a first communication bus (151) in the rail vehicle.

15. The method according to claim 13, comprising:
producing, in each of the least two railroad cars (111, 112, 11n), at least one vector signal representing an acceleration (aX, aY, aZ, aR, aP, aW) of the railroad car in at least one dimension, the at least one vector signal being produced by at least one accelerometer (211) and the at least one vector signal expressing the respective movement (m1, m2, mn) of the railroad car; and
generating the control signal (c11, c12, c13, c14, c21, c22, c23, c24, cn1, cn2, cn3, cn4) based on the at least one vector signal.

16. The method according to claim 13, comprising:
producing, in each of the least two railroad cars (111, 112, 11n), at least one speed signal (sω) representing a respective speed (ω) of a wheel (221) of the railroad car, the at least one speed signal (sω) being produced by at least one a rotational speed sensor (212) and the at least one speed signal (sω) expressing the movement (m1, m2, mn) of the railroad car, and
generating the control signal (c11, c12, c13, c14, c21, c22, c23, c24, cn1, cn2, cn3, cn4) based on the at least one speed signal (sω).

17. The method according to claim 13, further comprising:
receiving, in each of the control units (121-1, 121-2, 122-1, 122-2, 12n-1, 12n2), at least one of the at least one motion parameter expressing the respective movement (m2, mn) of each other railroad car in the rail vehicle;
determining, in each of the control units (121-1, 121-2, 122-1, 122-2, 12n-1, 12n-2), an average motion parameter (mavg) based on the at least one received motion parameter and a motion parameter expressing the movement (m1) the railroad car in which said respective one control unit (121-1) is found; and
generating, in each of the control units (121-1, 121-2, 122-1, 122-2, 12n-1, 12n-2), the control signal (c11, c12) to cause the brake actuator (1311a, 1311b) controlled by the control unit (121-1) to produce a respective brake-force signal (f11, f12) to the at least one brake unit (141-1; 141-2) causing the at least one pressing member to apply an increased braking force, if the motion parameter expresses the movement (m1) of the railroad car (111) has a magnitude larger than the average motion parameter (mavg).

18. The method according to claim 17, further comprising:
generating, in each of the control units (121-1, 121-2, 122-1, 122-2, 12n-1, 12n-2), the control signal (c11, c12) to cause the brake actuator (1311a, 1311b) controlled by the control unit (121-1) to produce a respective brake-force signal (f11, f12) to the at least one brake unit (141-1; 141-2) causing the at least one pressing member to apply an increased braking force, if the motion parameter expresses the movement (m1) of the railroad car (111) has a magnitude larger than the average motion parameter (mavg), and a decreased braking force, if the motion parameter expresses the movement (m1) of the railroad car (111) has a magnitude smaller than the average motion parameter (mavg).

19. The method according to claim 17, further comprising:
generating, in each of the control units (121-1, 121-2, 122-1, 122-2, 12n-1, 12n2), the control signal (c11, c12) to cause the brake actuator (1311a, 1311b) controlled by the control unit (121-1) to produce a respective brake-force signal (f11, f12) to the at least one brake unit (141-1; 141-2) causing the at least one pressing member to apply an increased braking force, if the motion parameter expresses that the movement (m1) of the railroad car (111) has a magnitude larger than the average motion parameter (mavg), and a maintained braking force, if the motion parameter expresses the movement (m1) the railroad car (111) has a magnitude equal to the average motion parameter (mavg).

20. The method according to claim 15, comprising exchanging the motion parameters expressing the respective movements (m1, m2, mn) of the railroad cars (111, 112, 11n) in the rail vehicle between the railroad cars (111, 112, 11n) via a second communication bus (152) in the rail vehicle.

21. The method according to claim 13, comprising generating the brake input signal (B) in response to at least one of a service brake command, an emergency brake command and a parking brake command.

22. The method according to claim 13, comprising:
producing a slip signal (s11) reflecting a degree of slip of each of the at least one wheel (221) whose rotation speed (ω) one of said brake actuators (1311a, 1311b, 1312a, 1312b, 1311a, 1311b, 1312a, 1312b, 13n1a, 13n1b, 13n2a, 13n2b) is configured, to reduce, the slip signal (s11) being produced by a measurement module (214) configured to monitor a rotation of the at least one wheel (221); and
if the degree of slip thereof exceeds a threshold value,
producing, in the brake actuator (1311a), the brake-force signal (f11) such that the brake unit (141-1) causes the pressing member to apply a braking force to the rotatable member, which braking force is lower than a braking force designated by the received control signal (c11).

23. A computer program (317; 417) loadable into a non-volatile data carrier (316; 416) communicatively connected to at least one processor (315; 415), the computer program (317; 417) comprising software for executing the method according claim 13 when the computer program (317; 417) is run on the at least one processor (315; 415).

24. A non-volatile data carrier (316; 416) containing the computer program (317; 417) of the claim 23.
